(19) United States
(12) Patent Application Publication
(10) Pub. No.: US 2004/0031859 A1
(43) Pub. Date: Feb. 19, 2004

(54) Apparatus and method for combined generation of heat and electricity

(76) Inventors: Erwin Johannes Maria Waalders, Lichtenvoorde (NL); Ronald Hubertus Theodorus Maria Hezemans, Silvolde (NL); Michel Martinus Willen Van Wezel, Terborg (NL); Cornelis Aplhonsus Waltherus Baijens, Westervoort (NL); Jozef Johannes Maria Luttikholt, Eibergen (NL); Gerardus Jacobus Josephine Beckers, Sint Maarten (NL)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/296,577

(22) PCT Filed: May 23, 2001
(86) PCT No.: PCT/NL01/00399

(30) Foreign Application Priority Data
May 26, 2000 (NL) 1015319

(51) Int. Cl. B60H 1/02; F24D 1/04; F24D 5/00

(52) U.S. Cl. 237/12.1

(57) ABSTRACT

The present invention relates to an apparatus for heating fluid in a pipe system, comprising: a first burner for heating pipes of the fluid circuit; a feed for air and/or fuel for causing combustion of this mixture by the burner; a second burner for heating a head of a generator for generating electrical energy; and an outlet pipe for discharging flue gases from the second burner into the space where the first burner is situated.

Due to the liberalizing of electricity supply in Europe, it will certainly become attractive in the future to generate electricity locally in a home as well as heat. If an excess of electricity is generated, this electricity can be supplied to the public grid, thereby decreasing the electricity bill of the user. Transport losses are reduced considerably due to decentralized generation of electricity.

PCT/NZ99/00017 relates to a burner and a Stirling engine for generating electrical energy. The engine is herein arranged in the liquid tank to enable discharge of heat.

The European patent application BP 0 528 109 proposes feeding the exhaust gases of a diesel generator to the combustion chamber of a burner for heating water.

Known from the European patent application 0 455 510 and the British patent GB 2 174 799 is the coupling of a Stirling engine into a domestic circuit. This relates to a hinged deflecting plate for screening the head of the Stirling engine in relation to the burner.

The American patent U.S. Pat. No. 4,534,319 describes a wood-burning stove with heat exchanger for heating water. This also includes electric resistance coils to prevent water from freezing.

The present invention provides an apparatus for heating fluid in a pipe system, comprising;

a first burner for heating pipes of the fluid circuit;

a second burner for heating a head of a generator for the purpose of generating electrical energy;

at least one fe d for air and/or fuel for causing combustion of this mixture by the burners; and

an outlet pipe for discharging flue gases from the second burner into the space where the first burner is situated.

In an apparatus according to the present invention the heat from the second burner is used both to generate electricity using the generator and to heat fluid in the pipes. Both burners preferably take a modulating form. The first burner is preferably provided with a choke valve so that it can supply the heat demand, which depends for instance on outside temperatures, thermostat settings and the like.

Electricity is preferably generated with a so-called Stirling generator which is of compact dimensions and has proven itself in practice, for instance in space travel applications.

Such a Stirling generator has to be adapted to the frequency of the electricity grid, which is for instance 50 or 60 Hz, and will thus cause an (audible) vibration which is undesirable. The Stirling generator is preferably suspended resiliently from cables so as to prevent this undesired effect.

Further advantages, features and details of the present invention will be elucidated on the basis of the following description with reference to the annexed drawings, in which:

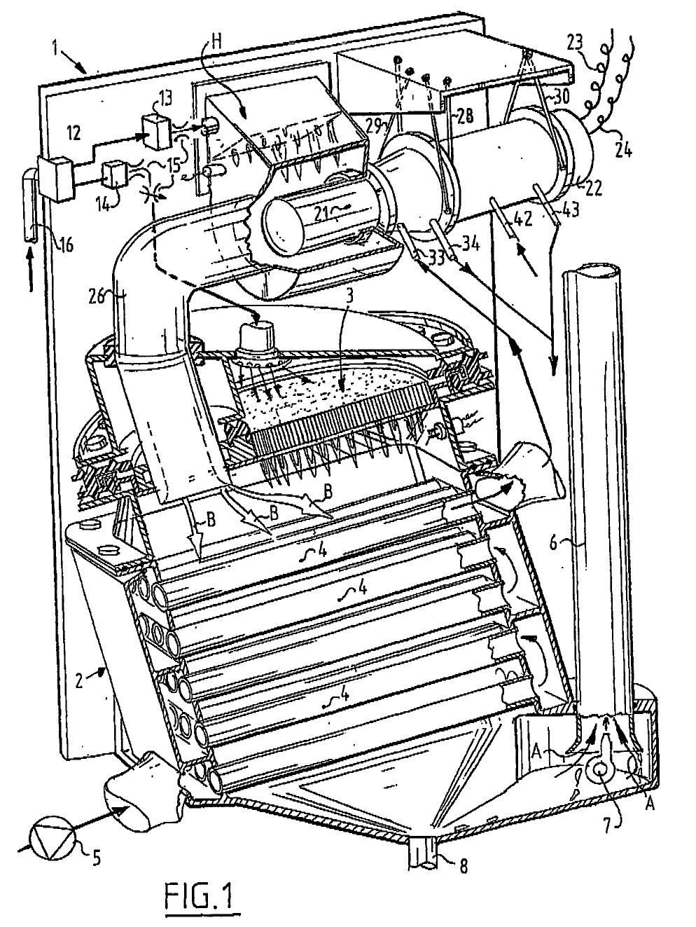

FIG. 1 shows a partly cut-away, schematic view of a first preferred embodiment of an apparatus according to the present invention; and

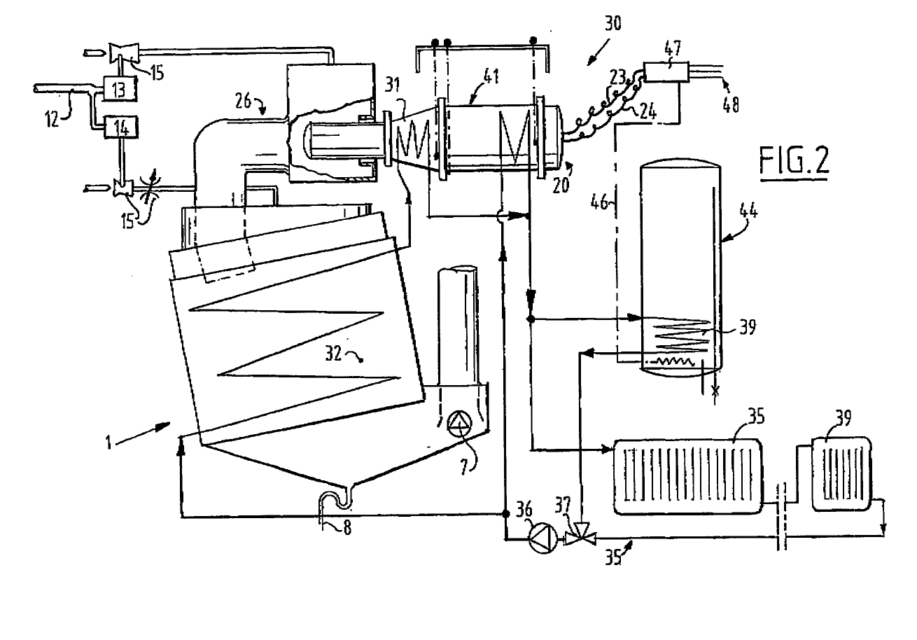

FIG. 2 shows a diagram of an installation incorporating the apparatus of FIG. 1.

An embodiment of an apparatus 1 (FIGS. 1, 2) for combined generation of heat and power in the form of electricity comprises a heating part 2 in which a peak burner 3 is placed on the head side to heat pipes 4 through which water flows for space heating and/or to heat a boiler. For this purpose the water is circulated using a schematically designated pump 5. After the flue gases coming from the burner have flowed along pipes 4 in downward direction, this flow is deflected as according to arrows A into an outlet pipe 6. In the present embodiment a fan 7 is included to discharge the flue gases. The apparatus is further provided on the underside with a condensation drain 8.

The construction shown in FIG. 1 and described above corresponds in considerable part with an apparatus currently marketed by the firm Atag Heating under the brand name “Blauwe Engel (Blue Angel) II”.

In the apparatus according to the present invention a second burner 11 is further arranged which, as shown schematically in FIG. 1, is connected to a gas feed line 12 shared with burner 3 via schematically designated control valves 13 and 14 in addition to a schematically designated control or choke valve 15 in the feed line 16 for the air, such as natural gas.

Burner 11 heats a head 21 of a Stirling generator 20 by generating electricity via lines 23, 24. Such a Stirling generator is known per se and described for instance in older American patents. The flue gases coming from burner 11 are forced along the head 21 for heating and guided via a pipe 26 as according to arrows B into the space under burner 13, whereby they likewise heat the water in pipes 4 to at least some extent and are discharged via chimney 6.

Through heating of the head 21 of Stirling generator 20 an alternating current of the desired frequency is generated by a generator part 22. Since the Stirling generator will therefore bring about an (audible) vibration, in the shown preferred embodiment the Stirling generator is suspended from wires 28, 29 and 30 which, as has been found in tests, prevent the vibrations being transferred to and being increased by a mounting plate and/or the housing.

As also shown particularly in the diagram of FIG. 2 of an installation 30 incorporating the apparatus 1, a cooling is arranged in Stirling generator 20 close to head 21 by means of a heat exchanger 31 which is connected in series behind heat exchanger 32. Temperature differences are thus reduced, and the efficiency of Stirling generator 20 and sufficient cooling are ensured.

As has been found, the system efficiency is maximal if the coldest fluid is used for cooling the flue gases, which is achieved by the above mentioned series connection. The connections 33 and 34 fed with partly fluid from heat exchanger 32, of heat exchanger 31 are likewise arranged in visible manner in FIG. 1.

Further forming part of cooling circuit 35 are a pump 36, a three-way valve 37, radiators 38 and a heat exchanger 39 for a boiler such as are connected in practice for heating of houses (and on commercial premises). A middle part 41 of Stirling engine 20 is likewise connected to the circuit 35 via connections 42 and 43 in order to also avoid a (too) high temperature of this middle part.

In the preferred embodiment there is likewise arranged in a boiler 44 a so-called electrical dump resistance 45 which is connected to a line 46 to a grid circuit 47 which provides the connection to the schematically designated grid 48. Should the Stirling engine 20 produce electrical energy which cannot be delivered to the grid, this energy can be supplied to the resistance 45 for heating the water in the boiler.

In a further embodiment (not shown) an energy-dissipating element can also be arranged outside the boiler.

The present invention is not limited to the above described preferred embodiment thereof; the rights sought are defined by the following claims, within the scope of which many modifications can be envisaged.

1. Apparatus for heating fluid in a pipe system, comprising:
a first burner for heating pipes of the fluid circuit;
a feed for air and/or fuel for causing combustion of this mixture by the burner;
a second burner for heating a head of a generator for generating electrical energy; and
an outlet pipe for discharging flue gases from the second burner into the space where the first burner is situated.

2. Apparatus as claimed in claim 1, wherein the generator comprises a Stirling engine.

3. Apparatus as claimed in claim 1 or 2, wherein the generator is suspended resiliently.

4. Apparatus as claimed in claim 3, wherein the generator is suspended from cables.

5. Apparatus as claimed in any of the foregoing claims, wherein the generator is provided with a cooling circuit which is connected to the fluid circuit.

6. Apparatus as claimed in claim 5, wherein the cooling circuit is connected in series behind the fluid circuit of the first burner.

7. Installation for generating heat and electricity, wherein an apparatus as claimed in any of the foregoing claims is applied which is connected to a boiler in which is placed a heat exchanger connected to the fluid circuit.

8. Installation as claimed in claim 7, wherein an electrical resistance connected to the Stirling generator is placed in the boiler.

9. Apparatus as claimed in one or more of the claims 1-5, provided with a choke valve in the gas/air feed for the first burner.

10. Method wherein an apparatus as claimed in any of the claims 1-9 is applied.
